(19) United States
(12) Patent Application Publication
(10) Pub. No.: US 2024/0249615 A1
(43) Pub. Date: Jul. 25, 2024

(54) WRONG-WAY VEHICLE DETERMINATION DEVICE

(71) Applicant: TOYOTA JIDOSHA KABUSHIKI KAISHA, Toyota-shi (JP)

(72) Inventors: Shinsaku YOSHINAKA, Susono-shi (JP); Shodai Horima, Susono-shi (JP)

(73) Assignee: TOYOTA JIDOSHA KABUSHIKI KAISHA, Toyota-shi (JP)

(21) Appl. No.: 18/499,475

(22) Filed: Nov. 1, 2023

(30) Foreign Application Priority Data
Jan. 20, 2023 (JP) 2023-007218

(51) Int. Cl. G08G 1/01; G08G 1/052

(52) U.S. Cl. CPC G08G 1/0133; G08G 1/052

(57) ABSTRACT

The wrong-way vehicle determination device includes a reception unit and a determination unit. The reception unit receives a plurality of pieces of vehicle behavior information corresponding to each of the plurality of vehicles and indicating vehicle behaviors and positions at which the vehicle behaviors occur. The determination unit determines whether there is a wrong-way vehicle based on a position at which a sudden vehicle behavior occurs based on a plurality of pieces of vehicle behavior information.

### CROSS-REFERENCE TO RELATED APPLICATION

This application claims priority to Japanese Patent Application No. 2023-007218 filed on Jan. 20, 2023, incorporated herein by reference in its entirety.

### BACKGROUND

### 1. Technical Field

The present disclosure relates to the technical field of wrong-way vehicle determination devices.

### 2. Description of Related Art

As an example of a device of this type, there has been proposed a device that notifies a vehicle of an abnormality when the advancing direction of travel locus data transmitted from the vehicle is different from the advancing direction during normal times (see Japanese Unexamined Patent Application Publication No. 2020-126505 (JP 2020-126505 A)).

### SUMMARY

In the technology described in JP 2020-126505 A, it is required that a wrong-way vehicle should be able to communicate with a server. Therefore, the technology described in JP 2020-126505 A involves a technical problem that the wrong-way vehicle cannot be detected when the wrong-way vehicle cannot communicate with the server.

The present disclosure has been made in view of the above problem, and has an object to provide a wrong-way vehicle determination device that can appropriately determine a wrong-way vehicle.

A wrong-way vehicle determination device according to one aspect of the present disclosure includes:
a reception unit that receives a plurality of pieces of vehicle behavior information corresponding to a plurality of vehicles and indicating vehicle behavior and a position at which the vehicle behavior is caused; and
a determination unit that determines whether a wrong-way vehicle is present based on a position at which abrupt behavior as the vehicle behavior is caused, based on the pieces of vehicle behavior information.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram showing the configuration of a wrong-way vehicle determination system according to an embodiment;

FIG. 2A is a conceptual diagram showing the behavior of a vehicle that encounters a wrong-way vehicle;

FIG. 2B is a conceptual diagram showing the behavior of a vehicle that encounters a wrong-way vehicle;

FIG. 3 is a diagram showing an example of a trajectory of a wrong-way vehicle;

FIG. 4 is a flowchart showing the operation of the vehicle according to the embodiment; and

FIG. 5 is a flowchart showing the operation of the server according to the embodiment.

### DETAILED DESCRIPTION OF EMBODIMENTS

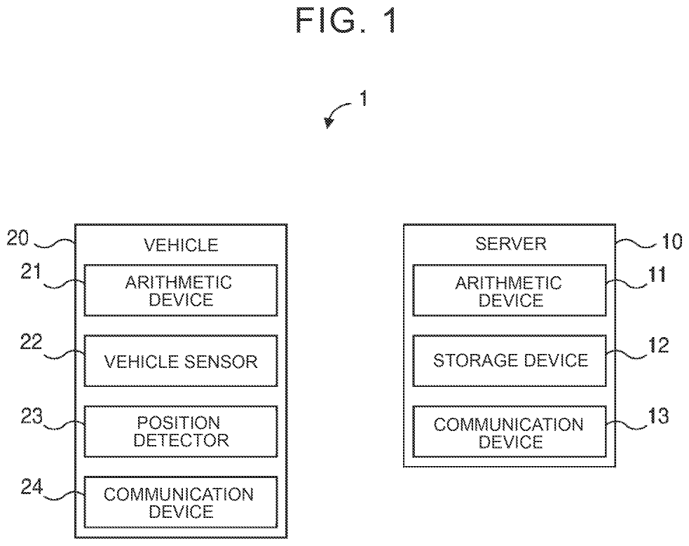

An embodiment of a wrong-way vehicle determination device will be described with reference to FIGS. 1 to 5. An embodiment of a wrong-way vehicle determination device will be described below using a wrong-way vehicle determination system 1 that includes a server 10 and a vehicle 20. Note that the server device 10 corresponds to an example of a wrong-way vehicle determination device.

In FIG. 1, a wrong-way vehicle determination system 1 includes a server 10 and a vehicle 20. The wrong-way vehicle determination system 1 may include a plurality of vehicles. However, in FIG. 1, only the vehicle 20 is illustrated for convenience.

The server 10 includes an arithmetic device 11, a storage device 12 and a communication device 13. The vehicle 20 includes an arithmetic device 21, vehicle sensors 22, a position detection device 23 and a communication device 24. The server 10 and the vehicle 20 are configured to communicate with each other via communication devices 13 and 24. The vehicle 20 may be a so-called connected car.

The arithmetic device 21 of the vehicle 20 may be an Electronic Control Unit (ECU). Note that the arithmetic device 21 may have an automatic driving function for automatically driving the vehicle 20. Vehicle sensors 22 may include at least one of a speed sensor, an acceleration sensor, and a yaw rate sensor. The position detection device 23 detects the position of the vehicle 20 using a Global Navigation Satellite System (GNSS) or the like. Since various existing aspects can be applied to the vehicle sensor 22 and the position detection device 23, a detailed description thereof will be omitted.

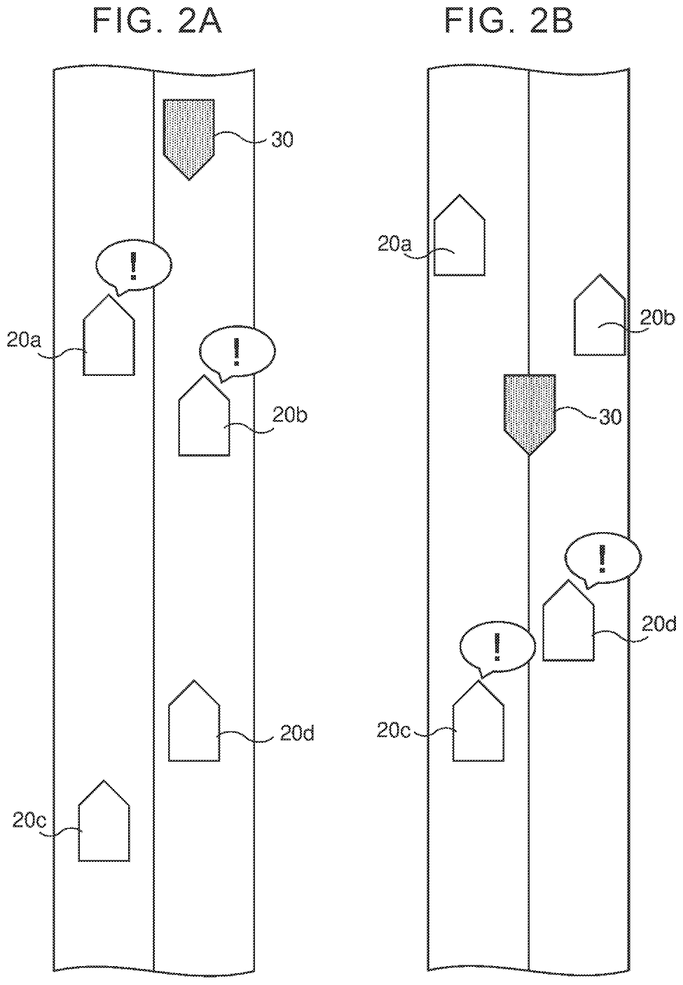

Here, the behavior of the vehicle (that is, the vehicle running in the forward direction) when there is a vehicle running in the wrong direction will be described with reference to FIGS. 2A and 2B. In FIGS. 2A and 2B, vehicles 20a, 20b, 20c and 20d are vehicles traveling in the forward direction. The vehicle 30 is a reverse running vehicle. The vehicles 20a, 20b, 20c, and 20d correspond to an example of the vehicle 20 described above. Hereinafter, a “vehicle traveling in the forward direction” will be referred to as a “forward vehicle.”

As shown in FIG. 2A, the drivers of the vehicles 20a and 20b who recognize the vehicle 30 running in the wrong direction perform driving operations to avoid the vehicle 30. In this case, a relatively large change in behavior occurs in each of the vehicles 20a and 20b. After that, as shown in FIG. 2B, the drivers of the vehicles 20c and 20d who have recognized the vehicle 30 running in the wrong direction perform driving operations to avoid the vehicle 30. In this case, a relatively large change in behavior occurs in each of the vehicles 20c and 20d. In this way, when forward-running vehicles (e.g., vehicles 20a, 20b, 20c, and 20d) avoid reverse-running vehicles (e.g., vehicle 30), the behavior of forward-running vehicles changes relatively significantly.

By the way, out of the plurality of forward running vehicles, the backward running vehicles are avoided in order from the forward running vehicles closest to the backward running vehicles. In the example shown in FIGS. 2A and 2B, the vehicles 20c and 20d avoid the vehicle 30 after the vehicles 20a and 20b avoid the vehicle 30 running in the wrong direction. Therefore, the time when the behavior of the vehicles 20a and 20b is relatively large differs from the time when the behavior of the vehicles 20c and 20d is relatively large.

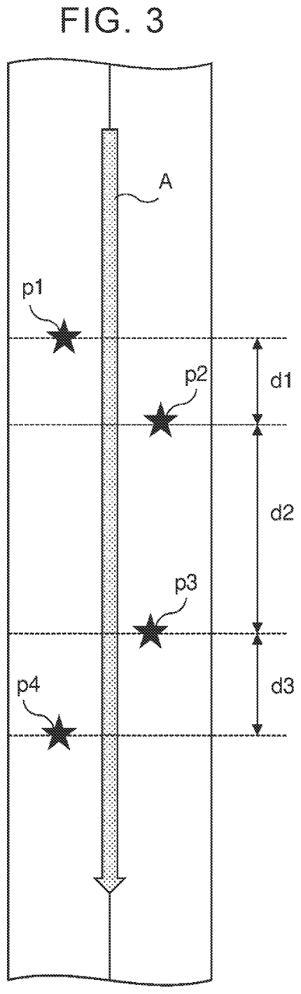

In FIG. 3, the position at which the vehicle 20a undergoes a relatively large change in behavior in order for the vehicle 20a to avoid the vehicle 30 is defined as a position p1. The position at which the vehicle 20b undergoes a relatively large change in behavior in order for the vehicle 20b to avoid the vehicle 30 is defined as a position p2. The position at which the vehicle 20c undergoes a relatively large change in behavior in order for the vehicle 20c to avoid the vehicle 30 is defined as a position p3. The position at which the vehicle 20d undergoes a relatively large change in behavior in order for the vehicle 20d to avoid the vehicle 30 is defined as a position p4. By connecting these positions p1 to p4 in the order of time when a relatively large change in behavior occurred in each of the vehicles 20a to 20d, it is possible to estimate the trajectory of the vehicle 30 traveling in the reverse direction as indicated by arrow A.

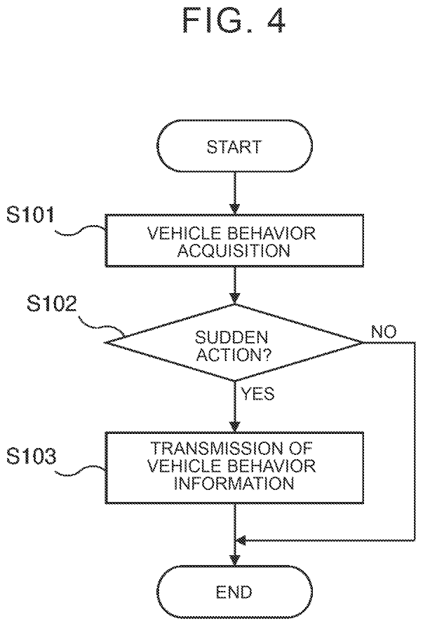

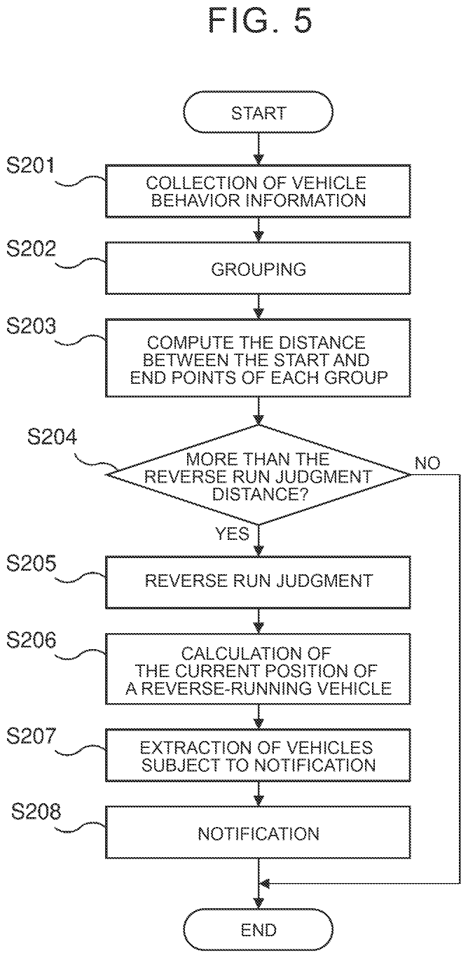

From the above-described viewpoint, the wrong-way vehicle determination system 1 determines whether a wrong-way vehicle exists based on a relatively large change in the behavior of the forward-running vehicle. The operation of the wrong-way vehicle determination system 1 will be specifically described with reference to the flowchart of FIGS. 4 and 5.

First, the operation of the vehicle 20 will be described with reference to the flowchart of FIG. 4. In FIG. 4, the arithmetic device 21 of the vehicle 20 acquires the behavior of the vehicle 20 based on the output of the vehicle sensor 22 (S101). Arithmetic device 21 determines whether the behavior of vehicle 20 has changed relatively significantly (in other words, whether or not a sudden behavior has occurred) based on the behavior of vehicle 20 acquired in S101 (S102). In the process of S102, when it is determined that the behavior of the vehicle 20 has not changed relatively significantly (S102: No), the operation shown in FIG. 4 is ended. After that, the process of S101 may be performed when the first predetermined time has passed. That is, the operation shown in FIG. 4 may be repeatedly performed at a cycle corresponding to the first predetermined time.

In the process of S102, when it is determined that the behavior of the vehicle 20 has changed relatively significantly (S102: Yes), the arithmetic device 21 identifies a position at which the behavior of the vehicle 20 has changed relatively greatly based on the output of the position detection device 23. The arithmetic device 21 transmits vehicle behavior information indicating that the behavior of the vehicle 20 has changed relatively significantly and the specified position to the server 10 via the communication device 24 (S103). After that, the process of S101 may be performed when the first predetermined time has passed.

The arithmetic device 21 may determine that the behavior of the vehicle 20 has changed relatively significantly at least one of the case where the longitudinal acceleration (also referred to as “longitudinal acceleration”) of the vehicle 20 is smaller than a predetermined acceleration threshold and the lateral jerk of the vehicle 20 is larger than the predetermined jerk threshold. Note that when the vehicle 20 is decelerating, the longitudinal acceleration takes a negative value.

Next, operations of the server 10 will be described with reference to the flowchart of FIG. 5. In FIG. 5, the arithmetic device 11 of the server 10 collects a plurality of vehicle behavior information from a plurality of vehicles corresponding to the vehicle 20 via the communication device 13 (in other words, receives a plurality of vehicle behavior information) (S201). The arithmetic device 11 adds time information indicating the time when the server 10 receives each of the collected vehicle behavior information. The arithmetic device 11 may store the collected pieces of vehicle behavior information in the storage device 12.

Arithmetic device 11 groups a plurality of pieces of vehicle behavior information (S202). Specifically, the arithmetic device 11 performs processing described below. Arithmetic device 11 calculates the distance in which the road extends at one position indicated by one piece of vehicle behavior information (that is, the position where the behavior of one vehicle corresponding to vehicle 20 has changed relatively significantly) and another position indicated by other vehicle behavior information (that is, the position where the behavior of one vehicle corresponding to the vehicle 20 has changed relatively greatly). For example, in FIG. 3, the distance in the road extending direction between positions p1 and p2 is distance d1. The distance in the direction in which the road extends between the positions p2 and p3 is the distance d2. The distance in the road extending direction between the positions p3 and p4 is the distance d3.

Arithmetic device 11 calculates a time difference between the time at which one piece of vehicle behavior information indicating a position (that is, a position at which the behavior of one vehicle corresponding to the vehicle 20 has changed relatively significantly) is received and the time at which another piece of vehicle behavior information indicating another position (that is, a position at which the behavior of the other vehicle corresponding to the vehicle 20 has changed relatively significantly), based on the time indicated by time information given to each of a plurality of pieces of vehicle behavior information (that is, time information indicating the time at which the server 10 receives the vehicle behavior information).

The arithmetic device 11 computes the speed based on the computed distance and the computed time difference. That is, the arithmetic device 11 computes the speed by dividing the computed distance by the computed time difference. For example, in FIG. 3, it is assumed that the time at which the vehicle behavior information indicating position p1 is received is time t1, and the time at which the vehicle behavior information indicating position p2 is received is time t2. In this case, the arithmetic device 11 may compute the speed by dividing the distance d1 by the time difference (time t1−time t2).

The arithmetic device 11 determines whether the calculated absolute value of the speed is greater than a predetermined upper limit speed. The predetermined upper speed limit may be set as an upper limit value of the speed that the wrong-way vehicle can take. The predetermined upper limit speed may be a fixed value, or a variable value that changes according to the type of road (for example, highway, arterial road, community road, etc.).

When it is determined that the absolute value of the calculated speed is greater than the predetermined upper limit speed, the arithmetic device 11 does not set the position indicated by the vehicle behavior information and the other position indicated by the other vehicle behavior information in the same group. This is because there is a possibility that one position and another position are geographically separated from each other. Alternatively, this is because there is a possibility that a relatively large change in behavior has occurred in a plurality of vehicles due to a cause (for example, an earthquake, etc.) other than that of the wrong-way vehicle.

When it is determined that the calculated absolute value of the speed is smaller than the predetermined upper limit speed, the arithmetic device 11 estimates the trajectory of the vehicle moving toward the other of the one position and the other position from the one position indicated by the one piece of vehicle behavior information and the other position indicated by the other piece of vehicle behavior information based on the time indicated by the given time information. For example, in FIG. 3, when the time t1 at which the vehicle behavior information indicating the position p1 is received is earlier than the time t2 at which the vehicle behavior information indicating the position p2 is received, the arithmetic device 11 estimates the trajectory of the vehicle moving from the position p1 toward the position p2. On the other hand, when the time t1 is later than the time t2, the arithmetic device 11 estimates the trajectory of the vehicle moving from the position p2 to the position p1.

The arithmetic device 11 determines whether the traveling direction is forward or backward based on the estimated trajectory. When it is determined that the traveling direction is the forward direction, the arithmetic device 11 does not set one position indicated by one vehicle behavior information and another position indicated by another vehicle behavior information in the same group. This is because the cause of the relatively large change in behavior of the plurality of vehicles is not the wrong-way vehicle. On the other hand, when it is determined that the traveling direction is the opposite direction, the arithmetic device 11 sets one position indicated by one vehicle behavior information and another position indicated by another vehicle behavior information into the same group.

After the processing of S202, the arithmetic device 11 calculates the distance between the starting point and the end point of the trajectory that appears by connecting the plurality of positions respectively indicated by the plurality of vehicle behavior information set in the same group (S203). For example, in FIG. 3, the vehicle behavior information indicating the position p1, the vehicle behavior information indicating the position p2, the vehicle behavior information indicating the position p3, and the vehicle behavior information indicating the position p4 are set in the same group. In this case, the distance between the start point and the end point of the trajectory appearing by connecting the positions p1 to p4 is the distance (d1+d2+d3).

Here, when a relatively large change in behavior occurs in a plurality of vehicles traveling in the forward direction due to, for example, an accident, the positions at which the relatively large change in behavior occurs are often close to each other. That is, the distance calculated in the process of S203 is often relatively short. On the other hand, when a plurality of vehicles traveling in the forward direction undergoes a relatively large change in behavior due to a wrong-way vehicle, the wrong-way vehicle travels a certain distance, and the distance calculated in the process of S203 is often relatively long.

Therefore, the arithmetic device 11 determines whether the distance calculated in the process of S203 is equal to or greater than the reverse running judgment distance (S204). In the process of S204, when it is determined that the distance calculated in the process of S203 is less than the reverse running determination distance (S204: No), the arithmetic device 11 determines that there is no reverse running vehicle, and end the operation shown in FIG. 5. After that, the process of S201 may be performed when the second predetermined time has passed. That is, the operation shown in FIG. 5 may be repeatedly performed at a cycle corresponding to the second predetermined time.

In the process of S204, when it is determined that the distance calculated in the process of S203 is equal to or greater than the reverse running determination distance (S204: Yes), the arithmetic device 11 determines that a reverse running vehicle exists (S205). The reverse-running determination distance is a value that determines whether a reverse-running vehicle exists, and may be set in advance as a fixed value or as a variable value according to some physical quantity or parameter.

Next, the arithmetic device 11 computes the current position of the wrong-way vehicle (S206). The arithmetic device 11 may calculate the current position of the wrong-way vehicle based on the position of the end point when calculating the distance in the processing of S203, the time indicated by the time information given to the vehicle behavior information indicating the position of the end point, the speed calculated for grouping in the processing of S202, and the current time.

Next, based on the current position of the wrong-way vehicle calculated in the process of S206, the arithmetic device 11 selects a plurality of vehicles capable of communicating with the server 10 to notify the presence of the wrong-way vehicle (i.e., notification target vehicle) are extracted (S207). Next, the arithmetic device 11 transmits alert information indicating that a wrong-way vehicle is present on the route to the vehicle extracted in the process of S207 via the communication device 13 (S208).

### Technical Effect

In the wrong-way vehicle determination system 1, among a plurality of vehicles (that is, vehicles corresponding to the vehicle 20) that can communicate with the server 10, based on the position of the vehicle that has undergone a relatively large change in behavior (that is, abrupt behavior) It is determined whether there is a reverse-running vehicle. In other words, the wrong-way vehicle determination system 1 focuses on the fact that the behavior of a plurality of vehicles traveling in the forward direction is disturbed due to the wrong-way vehicle, and determines whether there is a wrong-way vehicle. Therefore, according to the wrong-way vehicle determination system 1, even if the wrong-way vehicle cannot communicate with the server 10, the wrong-way vehicle can be determined appropriately.

Aspects of the disclosure derived from the embodiments described above will be described below.

A wrong-way vehicle determination device according to an aspect of the present disclosure includes: a reception unit for receiving a plurality of pieces of vehicle behavior information indicating a vehicle behavior and a position at which the vehicle behavior occurs; a determination unit for determining whether there is a wrong-way vehicle based on the vehicle behavior information, based on the position where the sudden behavior as the vehicle behavior occurs. In the above-described embodiment, the server 10 corresponds to an example of a wrong-way vehicle determination device, the communication device 13 corresponds to an example of a reception unit, and the arithmetic device 11 corresponds to an example of a determination unit.

In the wrong-way vehicle determination device, the determination unit may determine whether the wrong-way vehicle exists based on a trajectory that appears by connecting the plurality of locations where the sudden behavior occurred. In this aspect, the determination unit may determine that the wrong-way vehicle exists when the length of the locus is equal to or greater than a predetermined distance.

In the wrong-way vehicle determination device, the determination unit determines that the wrong-way vehicle is present when the speed calculated based on the time at which each of the plurality of vehicle behavior information is received and the plurality of locations where the sudden behavior occurs is equal to or less than a predetermined speed.

The present disclosure is not limited to the above-described embodiments, and can be appropriately modified within the scope not contrary to the gist or idea of the disclosure that can be read from the scope of claims and the entire specification. A wrong-way vehicle determination device is also included in the technical scope of the present disclosure.

What is claimed is:

1. A wrong-way vehicle determination device comprising:
a reception unit that receives a plurality of pieces of vehicle behavior information corresponding to a plurality of vehicles and indicating vehicle behavior and a position at which the vehicle behavior is caused; and
a determination unit that determines whether a wrong-way vehicle is present based on a position at which abrupt behavior as the vehicle behavior is caused, based on the pieces of vehicle behavior information.

2. The wrong-way vehicle determination device according to claim 1, wherein the determination unit determines whether the wrong-way vehicle is present based on a locus formed by connecting a plurality of positions at which the abrupt behavior is caused.

3. The wrong-way vehicle determination device according to claim 2, wherein the determination unit determines that the wrong-way vehicle is present when a length of the locus is equal to or greater than a predetermined distance.

4. The wrong-way vehicle determination device according to claim 1, wherein the determination unit determines that the wrong-way vehicle is present when a speed calculated based on a time when each of the pieces of vehicle behavior information is received and a plurality of positions at which the abrupt behavior is caused is equal to or less than a predetermined speed.
